(19) United States
(12) Patent Application Publication
(10) Pub. No.: US 2014/0369553 A1
(43) Pub. Date: Dec. 18, 2014

(54) METHOD FOR TRIGGERING SIGNAL AND IN-VEHICLE ELECTRONIC APPARATUS

(71) Applicant: UTECHZONE CO., LTD., New Taipei City (TW)

(72) Inventors: Chia-Chun Tsou, New Taipei City (TW); Chih-Heng Fang, New Taipei City (TW); Po-Tsung Lin, New Taipei City (TW)

(73) Assignee: UTECHZONE CO., LTD., New Taipei City (TW)

(21) Appl. No.: 13/971,840

(22) Filed: Aug. 21, 2013

(30) Foreign Application Priority Data
Jun. 14, 2013 (TW) 102121160

(51) Int. Cl. G06K 9/00

(52) U.S. Cl. CPC G06K 9/00315
USPC 382/103

(57) ABSTRACT

A signal triggering method and an in-vehicle electronic apparatus are provided. A plurality of images of a driver is continuously captured by using an image capturing unit, and a face motion information or an eyes open-shut information is obtained by detecting a face motion or an eyes open/shut action of the driver through the images. When the face motion information or the eyes open-shut information matches a threshold information, a specific signal is triggered and transmitted to a specific device.

### CROSS-REFERENCE TO RELATED APPLICATION

This application claims the priority benefit of Taiwan application serial no. 102121160, filed on Jun. 14, 2013. The entirety of the above-mentioned patent application is hereby incorporated by reference herein and made a part of this specification.

### BACKGROUND OF THE INVENTION

1. Field of the Invention

The present invention generally relates to an image processing technique, and more particularly, to a method for triggering a signal through a face recognition technique and an in-vehicle electronic apparatus.

2. Description of Related Art

The face recognition technology plays a very important role among image recognition technologies and is one of today's most focused technologies. Face recognition techniques are usually applied to human computer interfaces, home video surveillances, face recognition in biological detection, security and customs checks, public video surveillances, personal computers, and even the security monitoring in bank vaults.

Along with the development and widespread of technologies in recent years, the face recognition techniques have been applied to general digital cameras or video cameras. In addition, because more and more electronic apparatuses are equipped with cameras, applying face recognition techniques in different situations in our daily life has become very important.

However, because a human face comes with many features, if a single part on the human face is detected during a face recognition process, the recognition rate may be low and misjudgment may even be resulted. Thereby, how to avoid misjudgment in face recognition is a very important subject.

### SUMMARY OF THE INVENTION

Accordingly, the present invention is directed to a signal triggering method and an in-vehicle electronic apparatus, in which whether a specific signal is triggered is determined according to whether an action of a driver matches a threshold information.

The present invention provides an in-vehicle electronic apparatus. The in-vehicle electronic apparatus includes an image capturing unit and an operating device coupled to the image capturing unit. The image capturing unit captures a plurality of images of a driver. After the operating device receives the images, the operating device executes an image recognition procedure on each of the images to obtain a face motion information or an eyes open-shut information by detecting a face motion or an eyes open/shut action of the driver. Besides, when the face motion information or the eyes open-shut information matches a threshold information, the operating device triggers a distress signal and transmits the distress signal to a wireless communication unit.

According to an embodiment of the present invention, the image capturing unit is disposed in front of a driver's seat in a vehicle for capturing the images of the driver. The image capturing unit further has an illumination element and performs a light compensation operation through the illumination element. The operating device executes the image recognition procedure on each of the images to detect a nostrils position information of a face in the image, and the operating device obtains the face motion information or the eyes open-shut information according to the nostrils position information. The face motion information includes a head turning number, a head nodding number, and a head circling number of the driver, and the eyes open-shut information includes an eyes shut number of the driver.

The present invention provides a signal triggering method adapted to an in-vehicle electronic apparatus. The signal triggering method includes following steps. A plurality of images is continuously captured, where each of the images includes a face. A nostril area on the face is detected to obtain a nostrils position information. Whether the face turns is determined according to the nostrils position information, so as to obtain a face motion information. The face motion information is compared with a threshold information. When the face motion information matches the threshold information, a specific signal is triggered.

According to an embodiment of the present invention, the nostrils position information includes a first central point and a second central point of two nostrils. The step of determining whether the face turns according to the nostrils position information includes following steps. A horizontal gauge is performed according to the first central point and the second central point to locate a first boundary point and a second boundary point of the face. A central point of the first boundary point and the second boundary point is calculated served as a reference point. The reference point is compared with the first central point to determine whether the face turns towards a first direction. The reference point is compared with the second central point to determine whether the face turns towards a second direction. A number that the face turns towards the first direction and a number that the face turns towards the second direction during a predetermined period are calculated to obtain the face motion information.

According to an embodiment of the present invention, the step of determining whether the face turns according to the nostrils position information further includes following steps. A turning angle is obtained according to a straight line formed by the first central point and the second central point and a datum line. The turning angle is compared with a first predetermined angle to determine whether the face turns towards the first direction. The turning angle is compared with a second predetermined angle to determine whether the face turns towards the second direction. A number that the face turns towards the first direction and a number that the face turns towards the second direction during a predetermined period are calculated to obtain the face motion information.

According to an embodiment of the present invention, after the step of obtaining the nostrils position information, the signal triggering method further includes following steps. An eye search frame is estimated according to the nostrils position information to detect an eye object within the eye search frame. Whether the eye object is shut according to the size of the eye object, so as to obtain the eyes open-shut information. The face motion information and the eyes open-shut information are compared with the threshold information. When the face motion information and the eyes open-shut information match the threshold information, the specific signal is triggered.

According to an embodiment of the present invention, the step of determining whether the eye object is shut according to the size of the eye object includes following steps. When the height of the eye object is smaller than a height threshold and the width of the eye object is greater than a width threshold, it is determined that the eye object is shut. An eyes shut number of the eye object within the predetermined period is calculated to obtain the eyes open-shut information.

According to an embodiment of the present invention, after the step of triggering the specific signal, the specific signal is further transmitted to a specific device through a wireless communication unit.

The present invention provides another signal triggering method adapted to an in-vehicle electronic apparatus. The signal triggering method includes following steps. A plurality of images is continuously captured, where each of the images includes a face. A nostril area on the face is detected to obtain a nostrils position information. An eye search frame is estimated according to the nostrils position information to detect an eye object within the eye search frame. Whether the eye object is shut is determined according to the size of the eye object, so as to obtain an eyes open-shut information. The eyes open-shut information is compared with a threshold information. When the eyes open-shut information matches the threshold information, a specific signal is triggered.

The present invention provides yet another signal triggering method adapted to an in-vehicle electronic apparatus. The signal triggering method includes following steps. A plurality of images is continuously captured, where each of the images includes a face. A nostril area on the face is detected to obtain a nostrils position information. Whether the face turns is determined according to the nostrils position information, so as to obtain a face motion information. An eye search frame is estimated according to the nostrils position information to detect an eye object within the eye search frame. Whether the eye object is shut is determined according to the size of the eye object, so as to obtain an eyes open-shut information. The face motion information and the eyes open-shut information are compared with a threshold information. When the face motion information and the eyes open-shut information match the threshold information, a specific signal is triggered.

As described above, whether the action of a driver matches a threshold information is determined according to a nostrils position information, so as to determine whether to trigger a specific signal. Because the characteristic information of the nostrils is used, the operation load is reduced and misjudgement is avoided.

These and other exemplary embodiments, features, aspects, and advantages of the invention will be described and become more apparent from the detailed description of exemplary embodiments when read in conjunction with accompanying drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram of an in-vehicle electronic apparatus according to a first embodiment of the present invention.

FIG. 2 is a flowchart of a signal triggering method according to the first embodiment of the present invention.

FIG. 3 is a diagram of an image with a frontal face according to the first embodiment of the present invention.

FIG. 4A and FIG. 4B are diagrams of images with a turning face according to the first embodiment of the present invention.

FIG. 5A and FIG. 5B are diagrams of a nostril area according to the first embodiment of the present invention.

FIG. 6 is a flowchart of a signal triggering method according to a second embodiment of the present invention.

FIG. 7 is a diagram illustrating how an eye search frame is estimated according to the second embodiment of the present invention.

FIG. 8A and FIG. 8B are diagrams of an eye image area according to the second embodiment of the present invention.

FIG. 9 is a flowchart of a signal triggering method according to a third embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

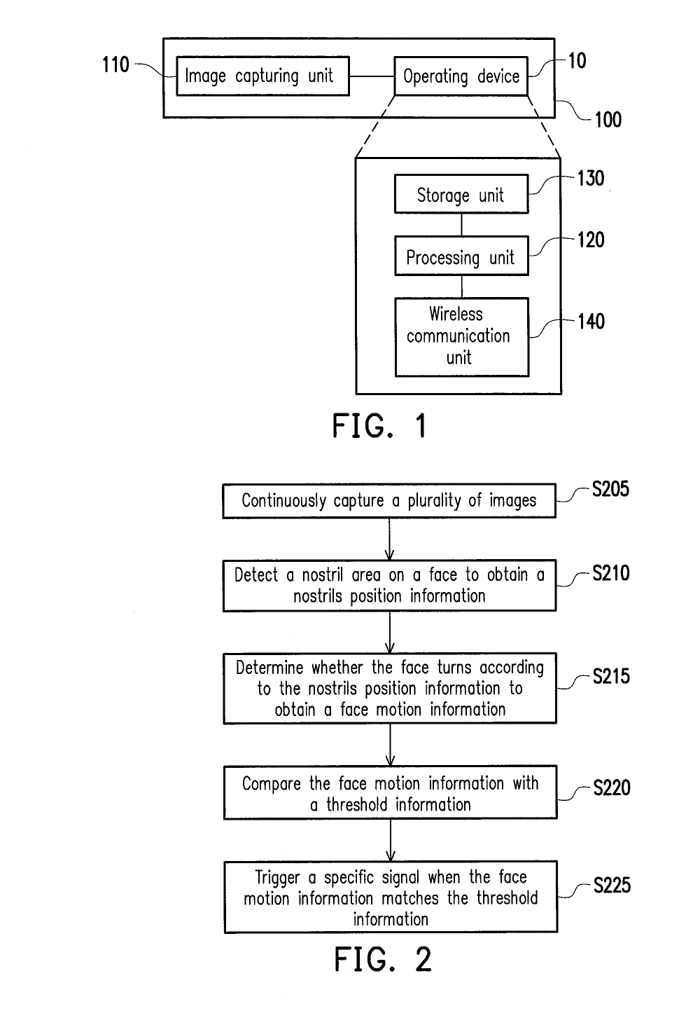

FIG. 1 is a diagram of an in-vehicle electronic apparatus according to the first embodiment of the present invention. Referring to FIG. 1, in the present embodiment, the in-vehicle electronic apparatus 100 includes an image capturing unit 110 and an operating device 10. The image capturing unit 110 is coupled to the operating device 10. In the present embodiment, the operating device 10 includes a processing unit 120, a storage unit 130, and a wireless communication unit 140. The processing unit 120 is respectively coupled to the image capturing unit 110, the storage unit 130, and the wireless communication unit 140. The image capturing unit 110 captures a plurality of images of a driver. The image capturing unit 110 may be a video camera or a camera with a charge coupled device (CCD) lens, a complementary metal oxide semiconductor transistors (CMOS) lens, or an infrared lens.

The image capturing unit 110 is disposed in front of the driver's seat in a vehicle for capturing the images of the driver. The image capturing unit 110 transmits the captured images to the operating device 10, and the operating device 10 executes an image recognition procedure on each of the images to obtain a face motion information or an eyes open-shut information by detecting a face motion or an eyes open/shut action of the driver. The face motion information includes a head turning number, a head nodding number, and a head circling number of the driver, and the eyes open-shut information includes an eyes shut number of the driver. Besides, when the face motion information or the eyes open-shut information matches a threshold information, the operating device 10 triggers a distress signal and transmits the distress signal to the wireless communication unit 140. For example, the processing unit 120 triggers a distress signal and transmits the distress signal to the wireless communication unit 140, and the distress signal is then transmitted to a specific device through the wireless communication unit 140. Aforementioned specific device may be an electronic equipment (for example, cell phone or computer) of a member in a neighborhood watch association or an electronic equipment in a vehicle management center.

The image capturing unit 110 further has a turning lens (not shown) for adjusting the shooting direction and angle. Herein the lens is adjusted to face the face of the driver so that each captured image contains the face of the driver. The nostrils on a human face present a darker color therefore can be easily identified, and other features on a human face can be obtained by using the features of the nostrils. To capture the nostrils of the driver clearly, the lens of the image capturing unit 110 is further adjusted to face the face of the driver at an elevation of 45°. Thus, the nostrils can be clearly shown in each image captured by the image capturing unit 110, so that the recognition of the nostrils may be enhanced, and the nostrils may be easily detected subsequently. In other embodiments, the image capturing unit 110 further has an illumination element. The illumination element is used for performing a light compensation operation when there is only insufficient light, such that the clarity of the captured images can be guaranteed.

The operating device 10 detects an action of the driver, and the operating device 10 triggers a specific signal and transmits the specific signal to a specific device when the driver's action matches a threshold information. The threshold information is at least one or a combination of a head turning number N1, a head nodding number N2, a head circling number N3, and an eyes shut number N4 of the driver. For example, the threshold information indicates that the driver turns his head rightwards for 2 times and then leftwards for 2 times during a predetermined period (for example, 3-7 seconds), the driver blinks his eyes for 3 times during a predetermined period (for example, 3 seconds), or the driver blinks his eyes for 3 times plus turns his head rightwards for 2 times and then leftwards for 2 times during a predetermined period (for example, 3-7 seconds). However, the threshold information mentioned above is only examples but not intended to limit the scope of the present invention.

The processing unit 120 may be a central processing unit (CPU) or a microprocessor. The storage unit 130 may be a non-volatile memory, a random access memory (RAM), or a hard disc. The wireless communication unit 140 may be a Third Generation (3G) mobile communication module, a General Packet Radio Service (GPRS) module, or a Wi-Fi module. However, the wireless communication unit 140 in the present invention is not limited to foregoing examples.

The present embodiment is implemented by using program codes. For example, the storage unit 130 stores a plurality of snippets. These snippets are executed by the processing unit 120 after the snippets are installed. For example, the storage unit 130 includes a plurality of modules. These modules respectively execute a plurality of functions, and each module is composed of one or more snippets. Aforementioned modules include an image processing module, a determination module and a signal triggering module. The image processing module executes an image recognition procedure on each image to detect a face motion or an eyes open/shut action of the driver, so as to obtain the face motion information or the eyes open-shut information. The determination module determines whether the face motion information or the eyes open-shut information matches a threshold information. The signal triggering module triggers a specific signal and transmits the specific signal to a specific device when the face motion information or the eyes open-shut information matches a threshold information. These snippets include a plurality of commands, and the processing unit 120 executes various steps of a signal triggering method through these commands. In the present embodiment, the in-vehicle electronic apparatus 100 includes only one processing unit 120. However, in other embodiments, the in-vehicle electronic apparatus 100 may include multiple processing units, and these processing units execute the installed snippets.

Below, various steps in the signal triggering method will be described in detail with reference to the in-vehicle electronic apparatus 100. FIG. 2 is a flowchart of a signal triggering method according to the first embodiment of the present invention. Referring to both FIG. 1 and FIG. 2, in step S205, the image capturing unit 110 continuously captures a plurality of images, where each of the images contains a face. To be specific, a sampling frequency is preset in the in-vehicle electronic apparatus 100 such that the image capturing unit 110 can continuously capture a plurality of images based on this sampling frequency. Additionally, in other embodiments, a start button (a physical button or a virtual button) is disposed in the in-vehicle electronic apparatus 100, and when the start button is enabled, the image capturing unit 110 is started to capture images and carry out subsequent processing.

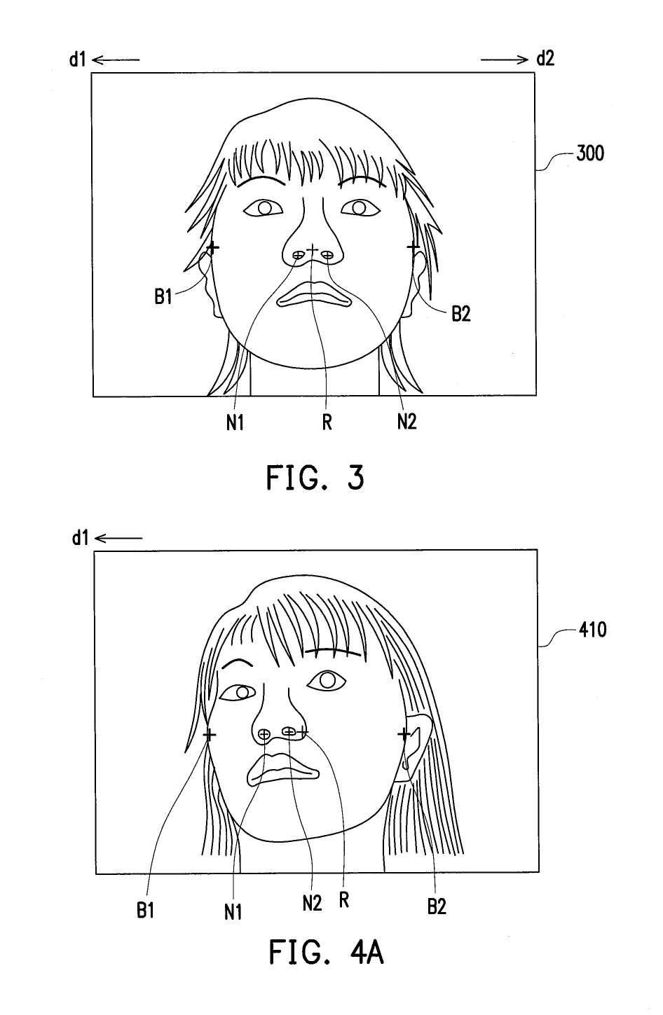

In step S210, the processing unit 120 detects a nostril area on the face in the captured images to obtain a nostrils position information. To be specific, the image capturing unit 110 transmits the images to the processing unit 120, and the processing unit 120 carries out face recognition in each of the images. The face in each image can be obtained through the AdaBoost algorithm or any other existing face recognition algorithm (for example, the face recognition action can be carried out by using Haar-like features). After detecting the face, the processing unit 120 searches for a nostril area (i.e., the position of the two nostrils) on the face. The nostrils position information may be a first central point and a second central point of two nostrils. FIG. 3 is a diagram of an image with a frontal face according to the first embodiment of the present invention. In the image 300 illustrated in FIG. 3, from the direction of the driver, the central point of the right nostril is considered a first central point N1, and the central point of the left nostril is considered a second central point N2.

Next, in step S215, the processing unit 120 determines whether the face turns according to the nostrils position information, so as to obtain the face motion information. Whether the face in the images turns towards a first direction d1 or a second direction d2 is determined by using the first central point N1 and the second central point N2. Herein from the direction of the driver, the rightward direction is considered the first direction d1, and the leftward direction is considered the second direction d2, as shown in FIG. 3. For example, the first central point N1 and the second central point N2 are compared with a reference point, and which direction the face turns towards is determined based on the relative position between the first central point N1 and the reference point and the relative position between the second central point N2 and the reference point.

For example, after obtaining the nostrils position information, the processing unit 120 performs a horizontal gauge according to the first central point N1 and the second central point N2 to locate a first boundary point B1 and a second boundary point B2 of the face. To be specific, based on the central point of the first central point N1 and the second central point N2, 2-10 (i.e., totally 4-20) pixel rows are respectively obtained above and below the axis X (i.e., the horizontal axis). Taking 5 pixel rows as an example, because the Y-coordinate of the central point of the first central point N1 and the second central point N2 is 240, totally 10 pixel rows having their Y-coordinates (241, 242, 243 . . . (upwards) and 239, 238, 237 . . . (downwards)) on the axis X are obtained. The boundaries (for example, from black pixels to white pixels) of the left and right cheeks are respectively located on each pixel row, and average values of the results located on the 10 pixel rows are calculated and served as the first boundary point B1 and the second boundary point B2.

After obtaining the boundaries of the two cheeks (i.e., the first boundary point B1 and the second boundary point B2), the processing unit 120 calculates the central point of the first boundary point B1 and the second boundary point B2 and serves the central point as a reference point R. Namely, assuming the coordinates of the first boundary point B1 to be (B_x1,B_y1) and the coordinates of the second boundary point B2 to be (B_x2,B_y2), the X-coordinate of the reference point R is (B_x1+B_x2)/2, and the Y-coordinate thereof is (B_y1+B_y2)/2.

Next, the reference point R is compared with the first central point N1 to determine whether the face turns towards the first direction d1. Besides, the reference point R is compared with the second central point N2 to determine whether the face turns towards the second direction d2. For example, when the first central point N1 is at the side of the reference point R towards the first direction d1, it is determined that the face turns towards the first direction d1, and when the second central point N2 is at the side of the reference point R towards the second direction d2, it is determined that the face turns towards the second direction d2. In addition, as shown in FIG. 3, when the reference point R is between the first central point N1 and the second central point N2, it is determined that the face faces forward and does not turn.

Thereafter, the processing unit 120 calculates the number that the face turns towards the first direction d1 and the number that the face turns towards the second direction d2 during a predetermined period (for example, 10 seconds), so as to obtain a face motion information. Aforementioned face motion information may be recorded as (d1,d1,d2,d2) to indicate that the face first turns towards the first direction d1 twice and then towards the second direction d2 twice. However, the implementation described above is only an example and is not intended to limit the scope of the present invention.

Next, in step S220, the processing unit 120 compares the face motion information with a threshold information. For example, the threshold information includes two thresholds, where one of the two thresholds is the threshold of the face turning towards the first direction d1 and the other one is the threshold of the face turning towards the second direction d2. Additionally, the sequence in which the face turns towards the first direction d1 and the second direction d2 is also defined in the threshold information.

In step S225, when the face motion information matches the threshold information, a specific signal is triggered. After the processing unit 120 triggers the corresponding specific signal, it further sends the specific signal to a specific device through the wireless communication unit 140. The specific signal may be a distress signal, and the specific device may be an electronic apparatus used by a member of a neighbourhood watch association or an electronic equipment (for example, a cell phone or a computer) in a vehicle management center. Or, if the in-vehicle electronic apparatus 100 is a cell phone, the driver can preset a phone number. After the processing unit 120 triggers the corresponding specific signal, a dialing function can be enabled by the specific signal such that the in-vehicle electronic apparatus 100 can call the specific device corresponding to the preset phone number.

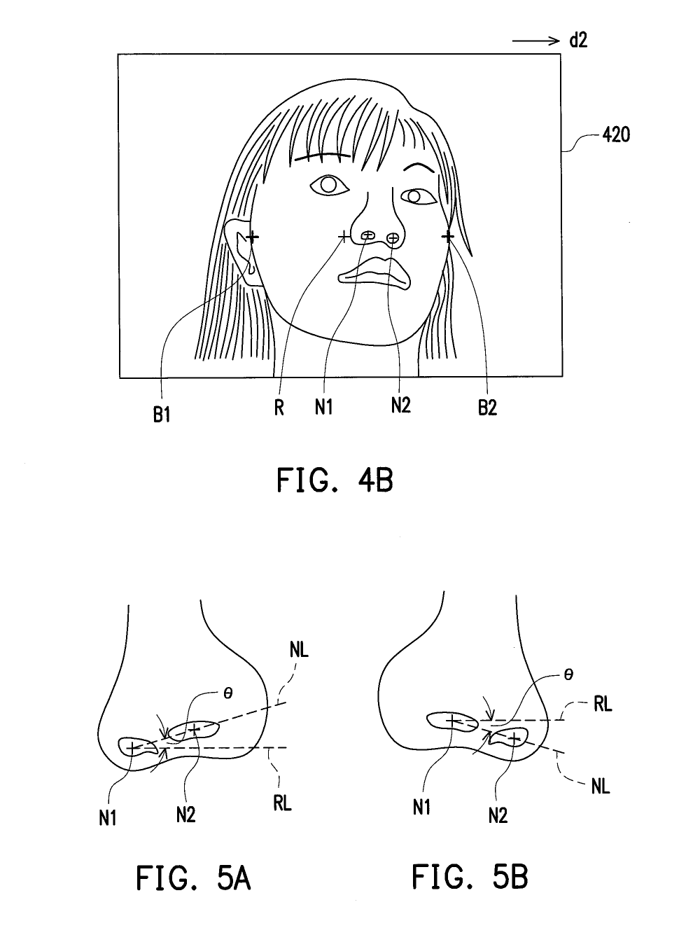

Below, how to determine whether the face turns will be explained with reference to another implementation. FIG. 4A and FIG. 4B are diagrams of images with a turning face according to the first embodiment of the present invention. FIG. 4A illustrates an image 410 of a face turning towards the first direction d1, and FIG. 4B illustrates an image 420 of the face turning towards the second direction d2.

Referring to FIG. 4A and FIG. 4B, herein the bottom-leftmost points in the images 410 and 420 are taken as the origins, the coordinates of the first central point N1 of the nostrils are (N1_x, N1_y), the coordinates of the second central point N2 of the nostrils are (N2_x, N2_y), and the coordinates of the reference point R (i.e., the central point of the first boundary point B1 and the second boundary point B2) are (R_x, R_y).

When the X-coordinate R_x of the reference point R is greater than the X-coordinate N1_x of the first central point N1, it is determined that the face turns towards the first direction d1, as shown in FIG. 4A. When the X-coordinate R_x of the reference point R is smaller than the X-coordinate N2_x of the second central point N2, it is determined that the face turns towards the second direction d2.

Moreover, in order to determine the turning direction of the face more accurately, a turning angle can be further involved. FIG. 5A and FIG. 5B are diagrams of a nostril area according to the first embodiment of the present invention. FIG. 5A illustrates a nostril area on a face turning towards the first direction d1, and FIG. 5B illustrates a nostril area on a face turning towards the second direction d2. In the present embodiment, a turning angle θ is obtained according to a straight line NL formed by the first central point N1 and the second central point N2 and a datum line RL. In other words, the angle formed by the straight line NL and the datum line RL with the first central point N1 as its vertex. Herein the datum line RL is a horizontal axis on the first central point N1, and the datum line RL is considered 0°.

Referring to FIG. 4A and FIG. 5A, when the first central point N1 is at the side of the reference point R towards the first direction d1 and the turning angle θ matches a first predetermined angle, it is determined that the face turns towards the first direction d1. For example, when the X-coordinate R_x of the reference point R is greater than the X-coordinate N1_x of the first central point N1 and the turning angle θ is greater than or equal to A° (A is between 2-5), it is determined that the face turns towards the first direction d1 (i.e., the face turns rightwards).

Referring to FIG. 4B and FIG. 5B, when the second central point N2 is at the side of the reference point R towards the second direction d2 and the turning angle θ matches a second predetermined angle, it is determined that the face turns towards the second direction d2. For example, when the X-coordinate R_x of the reference point R is smaller than the X-coordinate N2_x of the second central point N2 and the turning angle θ is smaller than or equal to −A°, it is determined that the face turns towards the second direction d2 (i.e., the face turns leftwards).

After determining that the face turns towards the first direction d1 or the second direction d2, the processing unit 120 further calculates the number that the face turns towards the first direction d1 and the number that the face turns towards the second direction d2 during a predetermined period, so as to obtain a face motion information.

In other embodiments, the horizontal axis on the second central point N2 (or the line connecting the first central point N1 and the second central point N2 of the frontal face) may also be served as the datum line, and the first predetermined angle and the second predetermined angle may be adjusted according to the actual requirement, which is not limited herein.

Moreover, the turning direction of the face may also be determined by using only the turning angle. To be specific, the turning angle θ is obtained according to the straight line NL formed by the first central point N1 and the second central point N2 and the datum line RL. After that, the turning angle θ is compared with the first predetermined angle to determine whether the face turns towards the first direction d1. Besides, the turning angle θ is compared with the second predetermined angle to determine whether the face turns towards the second direction d2. For example, when the turning angle θ is greater than or equal to A° (A is between 2-5), it is determined that the face turns towards the first direction d1 (i.e., the face turns rightwards). When the turning angle θ is smaller than or equal to −A°, it is determined that the face turns towards the second direction d2 (i.e., the face turns leftwards).

In the present embodiment, whether the face turns is determined by using the nostrils position information, and a specific signal is triggered when the turning direction and number match a threshold information. Thereby, feature information of the eyes is not used so that the operation load is reduced and misjudgement is avoided.

### Second Embodiment

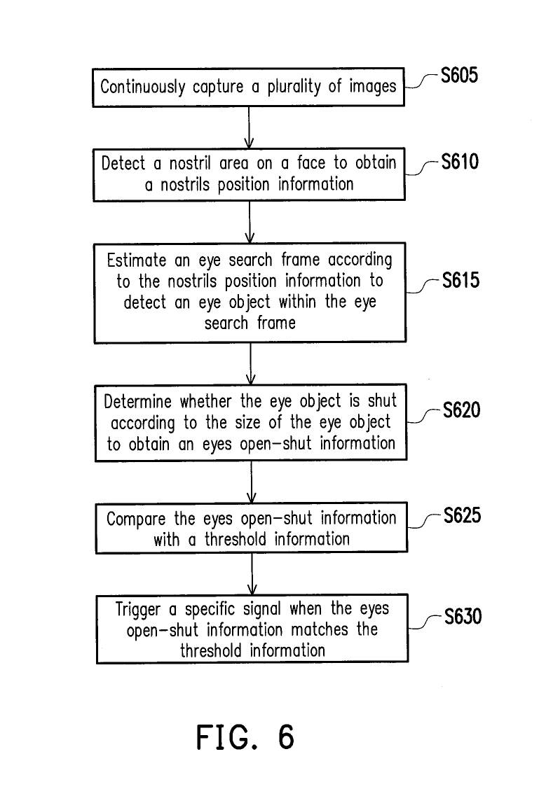

FIG. 6 is a flowchart of a signal triggering method according to the second embodiment of the present invention. Below, the signal triggering method will be described with reference to the in-vehicle electronic apparatus 100 illustrated in FIG. 1.

In step S605, the image capturing unit 110 continuously captures a plurality of images, where each of the images contains a face. Then, in step S610, the processing unit 120 detects a nostril area on the face to obtain a nostrils position information. Details of steps S605 and S610 can be referred to steps S205 and S210 described above therefore will not be described herein.

Next, in step S615, an eye search frame is estimated according to the nostrils position information to detect an eye object within the eye search frame. To be specific, compared to the eyes, the nostril is easier to identify in an image. Thus, after locating the nostril, an eye search frame is estimated upwards to locate an eye object within the eye search frame, so that the search area can be reduced.

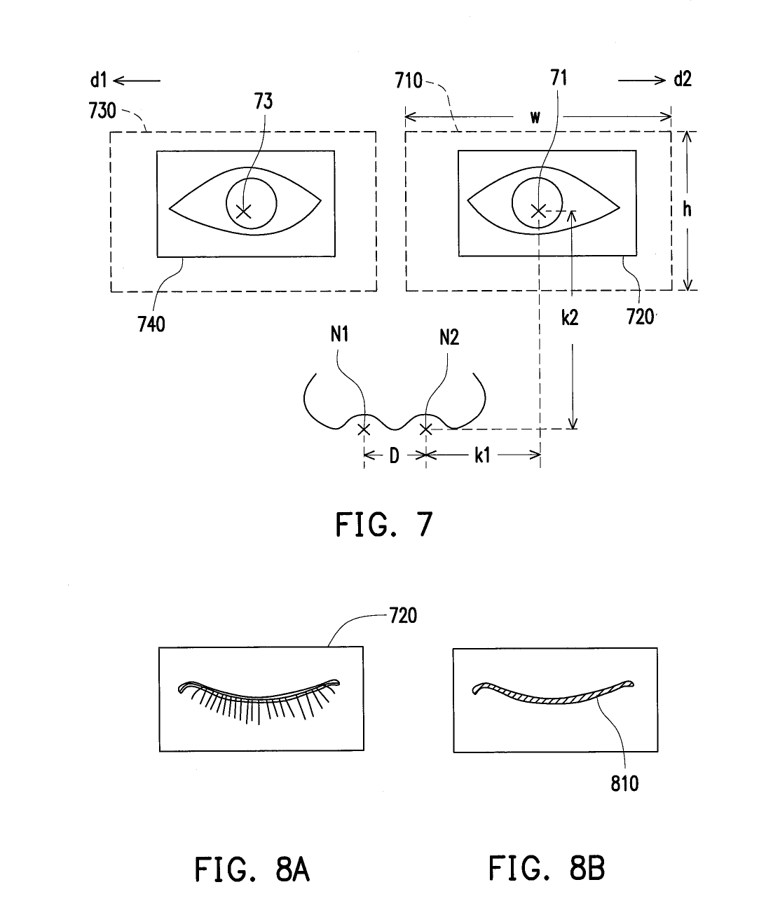

FIG. 7 is a diagram illustrating how an eye search frame is estimated according to the second embodiment of the present invention. After locating a first central point N1 and a second central point N2 of the two nostrils, the processing unit 120 calculates the distance D between the first central point N1 and the second central point N2. Then, the processing unit 120 estimates the central point, length, and width of the eye search frame according to the distance D.

To be specific, taking the second central point N2 (N2_x, N2_y) as the starting point, a first estimation value k1 is added to the X-coordinate thereof towards the second direction d2, and a second estimation value k2 is added to the Y-coordinate thereof upwards, so as to obtain a central point 71 (i.e., the X-coordinate of the central point 71 is C_x=N2_x+k1, and the Y-coordinate thereof is C_y=N2_y+k2). The estimation values k1 and k2 may be set as k1=D×e1 and k2=D×e2, where 1.3<e1<2.0, and 1.5<e2<2.2. However, the estimation values k1 and k2 are not limited herein and may be adjusted according to the actual requirement. After the central point 71 is obtained, an eye search frame 710 is obtained according to pre-defined width w and height h, where the width w is greater than the height h. For example, the width w is 2×22 pixels, and the height h is 2×42 pixels.

Similar to the method described above, taking the first central point N1 (N1_x,N1_y) as the starting point, the first estimation value k1 is deducted from the X-coordinate towards the first direction d1, and the second estimation value k2 is added to the Y-coordinate upwards, so as to obtain another central point 73. After the central point 73 is obtained, another eye search frame 730 is obtained according to pre-defined width w and height h. In other embodiments, the starting point may also be the central point of the first central point N1 and the second central point N2, which is not limited in the present invention.

After obtaining the eye search frames 710 and 730, the processing unit 120 obtains more precise eye image areas 720 and 740 in the eye search frames 710 and 730. Another embodiment will be described below by taking the left eye of the driver as an example.

FIG. 8A and FIG. 8B are diagrams of an eye image area according to the second embodiment of the present invention. FIG. 8A illustrates the eye image area 720 in FIG. 7 in an eye-shut state. After the eye image area 720 is obtained within the eye search frame 710, the contrast of the eye image area 720 is adjusted to obtain an enhanced image. Specifically, a gain value and an offset value of the eye image area 720 are adjusted. For example, an average value avg of the grayscales of all pixels in the eye image area 720 is calculated. If the average value avg is smaller than 150, the offset value is set as the negative value of the average value avg (i.e., −avg), and the gain value is set as G1, where 3.2<G1<2.1. If the average value avg is not smaller than 150, the offset value is set as the negative value of the average value avg (i.e., −avg), and the gain value is set as G2, where 1.9<G2<2.5.

Thereafter, a denoising process is performed on the enhanced image to obtain a denoised image. For example, the denoising process is performed by using a 3×3 matrix in which every element has the value 1. After that, an edge sharpening process is performed on the denoised image to obtain a sharpened image. For example, the edge sharpening process is performed by using an improved Soble mask having the value (1, 0, 0, 0, −1). Next, a binaryzation process is performed on the sharpened image to obtain a binarized image. Then, the edge sharpening process is performed on the binarized image again to obtain an eye object 810, as shown in FIG. 8B.

Referring to FIG. 6 again, after the eye object 810 is obtained, in step S620, the processing unit 120 determines whether the eye object is shut according to the size of the eye object 810, so as to obtain an eyes open-shut information. For example, when the height of the eye object 810 is smaller than a height threshold (for example, the height threshold is between 5-7 pixels) and the width of the eye object 810 is greater than a width threshold (for example, the width threshold is between 60-80 pixels), the processing unit 120 determines that the eye object 810 is shut. Otherwise, the processing unit 120 determines that the eye object 810 is open. Thereafter, the processing unit 120 calculates an eyes shut number of the eye object during a predetermined period to obtain the eyes open-shut information.

Next, in step S625, the eyes open-shut information is compared with a threshold information. The threshold information includes an eye blinking threshold (for example, 3 times). In step S630, when the eyes open-shut information matches the threshold information, a specific signal is triggered. After the processing unit 120 triggers the corresponding specific signal, it further sends the specific signal to a specific device through the wireless communication unit 140.

In the present embodiment, an eye object is located by using the nostrils position information to determine whether the driver blinks his eyes, and a specific signal is triggered when the number of blinks matches a threshold. An appropriate eye search frame is obtained by using the feature information of the easily recognized nostrils, and an eye image area is then obtained in the eye search frame for detecting an eye object. Thereby, the recognition complexity is greatly reduced and the recognition efficiency is improved.

### Third Embodiment

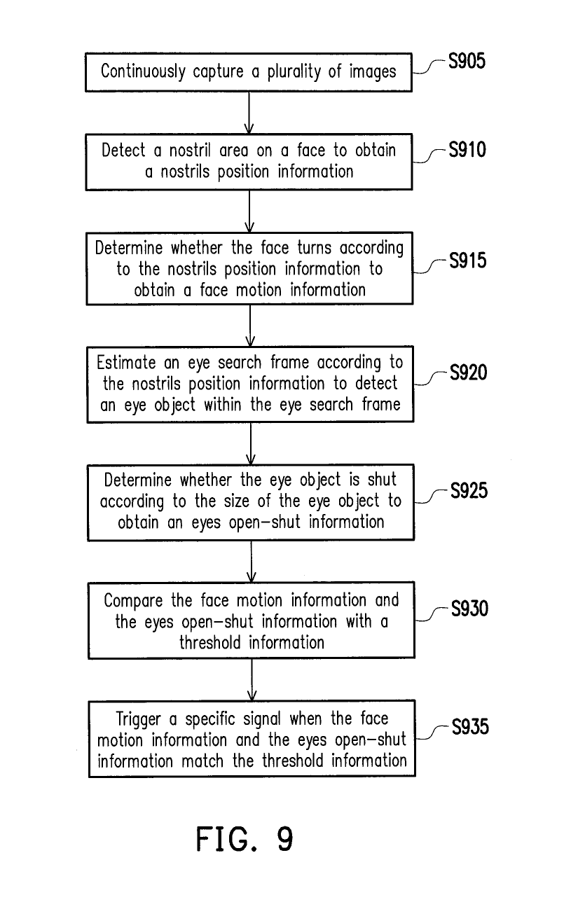

In the present embodiment, whether a specific signal is triggered is determined according to both a face motion information and an eyes open-shut information. FIG. 9 is a flowchart of a signal triggering method according to the third embodiment of the present invention. The signal triggering method in the present embodiment will be described below with reference to both FIG. 1 and FIG. 9. In step S905, the image capturing unit 110 continuously captures a plurality of images, where each of the images contains a face. Then, in step S910, the processing unit 120 detects a nostril area on the face to obtain a nostrils position information. The details of steps S905 and S910 can be referred to the steps S205 and S210 described above therefore will not be described herein.

After the nostrils position information is obtained, whether the face turns is determined according to the nostrils position information, and an eye object is located according to the nostrils position information to determine whether the eye object is shut (the driver blinks). In the present embodiment, the sequence of determining whether the face turns and detecting whether the eye object is shut is only an example for the convenience of description but not intended to limit the scope of the present invention.

In step S915, the processing unit 120 determines whether the face turns according to the nostrils position information, so as to obtain a face motion information. The details of step S915 can be referred to step S215 in the first embodiment therefore will not be described herein.

Next, in step S920, an eye search frame is estimated according to the nostrils position information to detect an eye object in the eye search frame. In step S925, the processing unit 120 determines whether the eye object is shut according to the size of the eye object, so as to obtain an eyes open-shut information. The details of steps S920 and S925 can be referred to steps S615 and S620 in the second embodiment therefore will not be described herein.

After the face motion information and the eyes open-shut information are obtained, in step S930, the face motion information and the eyes open-shut information are compared with a threshold information. Herein the threshold information includes three thresholds: a blink threshold, a threshold of the face turning towards a first direction, and a threshold of the face turning towards a second direction. Besides, the sequence of the face turning towards the first direction and towards the second direction is defined in the threshold information.

Eventually, in step S630, when the face motion information and the eyes open-shut information match the threshold information, a specific signal is triggered. After the processing unit 120 triggers the corresponding specific signal, it further sends the specific signal to a specific device through the wireless communication unit 140.

As described above, in an embodiment of the present invention, the action of a driver can be captured through a human computer interface without disturbing or bothering any other people, and a specific signal is triggered when the action of the driver satisfies a specific condition (i.e., a threshold information). In the embodiments described above, a nostril area on a face is first located to obtain a nostrils position information, and whether the driver's action matches a threshold information is then determined according to the nostrils position information, so as to determine whether to trigger a specific signal. For example, when the driver is not able to call for help in a state of emergency, the driver can trigger a specific signal by turning his head and/or blinking his eyes, so that the safety of the driver can be protected.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An in-vehicle electronic apparatus, comprising:
an image capturing unit, capturing a plurality of images of a driver; and
an operating device, coupled to the image capturing unit, receiving the images, and executing an image recognition procedure on each of the images to obtain a face motion information or an eyes open-shut information by detecting a face motion or an eyes open/shut action of the driver, and when the face motion information or the eyes open-shut information matches a threshold information, triggering a distress signal and transmitting the distress signal to a wireless communication unit.

2. The in-vehicle electronic apparatus according to claim 1, wherein the image capturing unit is disposed in front of a driver's seat in a vehicle for capturing the images of the driver;
wherein the image capturing unit has an illumination element, and a light compensation operation is performed through the illumination element.

3. The in-vehicle electronic apparatus according to claim 1, wherein the operating device executes the image recognition procedure on each of the images to detect a nostrils position information of a face in the image, and the operating device obtains the face motion information or the eyes open-shut information according to the nostrils position information.

4. The in-vehicle electronic apparatus according to claim 1, wherein the face motion information comprises a head turning number, a head nodding number, and a head circling number of the driver, and the eyes open-shut information comprises an eyes shut number of the driver.

5. A method for triggering a signal, for an in-vehicle electronic apparatus, the method comprising:
continuously capturing a plurality of images, wherein each of the images comprises a face;
detecting a nostril area of the face to obtain a nostrils position information;
determining whether the face turns according to the nostrils position information to obtain a face motion information;
comparing the face motion information with a threshold information; and
when the face motion information matches the threshold information, triggering a specific signal.

6. The method according to claim 5, wherein the nostrils position information comprises a first central point and a second central point of two nostrils;
wherein the step of determining whether the face turns according to the nostrils position information comprises:
performing a horizontal gauge according to the first central point and the second central point to locate a first boundary point and a second boundary point of the face;
calculating a central point of the first boundary point and the second boundary point, and serving the central point as a reference point;
comparing the reference point and the first central point to determine whether the face turns towards a first direction;
comparing the reference point with the second central point to determine whether the face turns towards a second direction; and
calculating a number that the face turns towards the first direction and a number that the face turns towards the second direction during a predetermined period to obtain the face motion information.

7. The method according to claim 6, wherein the step of determining whether the face turns according to the nostrils position information comprises:
obtaining a turning angle according to a straight line formed by the first central point and the second central point and a datum line;
when the first central point is at a side of the reference point to the first direction and the turning angle matches a first predetermined angle, determining that the face turns towards the first direction; and
when the second central point is at a side of the reference point to the second direction and the turning angle matches a second predetermined angle, determining that the face turns towards the second direction.

8. The method according to claim 5, wherein the nostrils position information comprises a first central point and a second central point of two nostrils;
wherein the step of determining whether the face turns according to the nostrils position information comprises:
obtaining a turning angle according to a straight line formed by the first central point and the second central point and a datum line;
comparing the turning angle with a first predetermined angle to determine whether the face turns towards the first direction;
comparing the turning angle with a second predetermined angle to determine whether the face turns towards the second direction; and
calculating a number that the face turns towards the first direction and a number that the face turns towards the second direction during a predetermined period, so as to obtain the face motion information.

9. The method according to claim 5, wherein after the step of obtaining the nostrils position information, the method further comprises:
estimating an eye search frame according to the nostrils position information to detect an eye object in the eye search frame;
determining whether the eye object is shut according to a size of the eye object, so as to obtain an eyes open-shut information;
comparing the face motion information and the eyes open-shut information with the threshold information; and
when the face motion information and the eyes open-shut information match the threshold information, triggering the specific signal.

10. The method according to claim 9, wherein the step of determining whether the eye object is shut according to the size of the eye object comprises:
when a height of the eye object is smaller than a height threshold and a width of the eye object is greater than a width threshold, determining that the eye object is shut; and
calculating an eyes shut number of the eye object during a predetermined period to obtain the eyes open-shut information.

11. The method according to claim 5, wherein after the step of triggering the specific signal, the method further comprises:
transmitting the specific signal to a specific device through a wireless communication unit.

12. A method for triggering a signal, for an in-vehicle electronic apparatus, the method comprising:
continuously capturing a plurality of images, wherein each of the images comprises a face;
detecting a nostril area on the face to obtain a nostrils position information;
estimating an eye search frame according to the nostrils position information to detect an eye object in the eye search frame;
determining whether the eye object is shut according to a size of the eye object, so as to obtain an eyes open-shut information;
comparing the eyes open-shut information with a threshold information; and
when the eyes open-shut information matches the threshold information, triggering a specific signal.

13. The method according to claim 12, wherein the step of detecting the eye object in the eye search frame comprises:
obtaining an eye image area in the eye search frame;
adjusting a contrast of the eye image area to obtain an enhanced image;
performing a denoising process on the enhanced image to obtain a denoised image;
performing an edge sharpening process on the denoised image to obtain a sharpened image;
performing a binarization process on the sharpened image to obtain a binarized image; and
performing the edge sharpening process on the binarized image to obtain the eye object.

14. The method according to claim 12, wherein the step of determining whether the eye object is shut according to the size of the eye object comprises:
when a height of the eye object is smaller than a height threshold and a width of the eye object is greater than a width threshold, determining that the eye object is shut; and
calculating an eyes shut number of the eye object during a predetermined period, so as to obtain the eyes open-shut information.

15. The method according to claim 12, wherein after the step of triggering the specific signal, the method further comprises:
transmitting the specific signal to a specific device through a wireless communication unit.

16. A method for triggering a signal, for an in-vehicle electronic apparatus, the method comprising:
continuously capturing a plurality of images, wherein each of the images comprises a face;
detecting a nostril area on the face to obtain a nostrils position information;
determining whether the face turns according to the nostrils position information, so as to obtain a face motion information;
estimating an eye search frame according to the nostrils position information to detect an eye object in the eye search frame;
determining whether the eye object is shut according to a size of the eye object, so as to obtain an eyes open-shut information;
comparing the face motion information and the eyes open-shut information with the threshold information; and
when the face motion information and the eyes open-shut information matches the threshold information, triggering a specific signal.

17. The method according to claim 16, wherein the nostrils position information comprises a first central point and a second central point of two nostrils;
wherein the step of determining whether the face turns according to the nostrils position information comprises:
performing a horizontal gauge according to the first central point and the second central point to locate a first boundary point and a second boundary point of the face;
calculating a central point of the first boundary point and the second boundary point, and serving the central point as a reference point;
comparing the reference point with the first central point to determine whether the face turns towards a first direction;
comparing the reference point with the second central point to determine whether the face turns towards a second direction; and
calculating a number that the face turns towards the first direction and a number that the face turns towards the second direction during a predetermined period to obtain the face motion information.

18. The method according to claim 17, wherein the step of determining whether the face turns according to the nostrils position information comprises:
obtaining a turning angle according to a straight line formed by the first central point and the second central point and a datum line;
when the first central point is at a side of the reference point to the first direction and the turning angle matches a first predetermined angle, determining that the face turns towards the first direction; and
when the second central point is at a side of the reference point to the second direction and the turning angle matches a second predetermined angle, determining that the face turns towards the second direction.

19. The method according to claim 16, wherein the step of detecting the eye object in the eye search frame comprises:
obtaining an eye image area in the eye search frame;
adjusting a contrast of the eye image area to obtain an enhanced image;
performing a denoising process on the enhanced image to obtain a denoised image;
performing an edge sharpening process on the denoised image to obtain a sharpened image;
performing a binaryzation process on the sharpened image to obtain a binarized image; and
performing the edge sharpening process on the binarized image to obtain the eye object.

20. The method according to claim 16, wherein the step of determining whether the eye object is shut according to the size of the eye object comprises:
when a height of the eye object is smaller than a height threshold and a width of the eye object is greater than a width threshold, determining that the eye object is shut; and
calculating an eyes shut number of the eye object during a predetermined period to obtain the eyes open-shut information.

21. The method according to claim 16, wherein after the step of triggering the specific signal, the method further comprises:
transmitting the specific signal to a specific device through a wireless communication unit.
